(19) United States
(12) Patent Application Publication
(10) Pub. No.: US 2004/0108058 A1
(43) Pub. Date: Jun. 10, 2004

(54) Lamination process of packaging substrate

(76) Inventors: Jen-I Kuo, Chiayii (TW); Su-Juinn Da, Taipei (TW); Shuh-Sen Jen, Bade City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/065,980

(22) Filed: Dec. 6, 2002

(51) Int. Cl. B32B 31/00

(52) U.S. Cl. 156/293

(57) ABSTRACT

In a lamination process, a plurality of substrate layers are stacked on one another, a topmost substrate layer having an opening therein. A fill material is formed under liquid form in the opening, and is solidified. Thereafter, the substrate layers are heated and pressed between two pressing plates in a press-bonding process, the fill material receiving a pressure of the pressing plates. The pressing plates have planar pressing surfaces, which therefore prevents alteration of the cavity shape and size.

### BACKGROUND OF INVENTION

1. Field of the Invention

The invention relates generally to a fabrication process of a packaging substrate and, more particularly, a lamination process in the fabrication of a packaging substrate.

2. Description of the Related Art

One type of semiconductor packaging structure known in the art includes a substrate-type carrier on which is mounted a die. The substrate-type carrier typically comprises a plurality of patterned trace layers alternately stacked with a plurality of insulating layers, the trace layers being electrically connected to one another by means of plated through-holes or conductive vias. The above structure is usually fabricated according to either a laminated construction or a built-up construction. The, obtained substrate-type carrier has dense circuit layout and good electrical properties. The die is conventionally connected to the substrate-type carrier via conductive wires or a flip chip interconnection structure.

The insulating material inside the substrate-type carrier may be either an organic material or an inorganic material. Organic materials commonly used are, for example, FR-4 resins, FR-5 resins, bismaleimide-triazine, epoxy, etc. Inorganic materials commonly used are, for example, ceramic or glass materials. When the insulating material is made of a ceramic-based material, the fabrication of the substrate-carrier is usually achieved from conventionally known ceramic green tapes. The green tapes are principally constituted of ceramic powder, glass, and a binder. Via holes and openings are formed through the green tapes to respectively define conductive vias and a cavity in the green tapes to receive a die therein. The conductive vias are typically formed by filling a conductive material in the via holes to interconnect conductive traces of the green tapes.

FIG. 1A through FIG. 1C are schematic views particularly illustrating a lamination process of green tapes in the fabrication of a packaging substrate known in the art.

Once the green tapes have been formed, they are prepared for lamination with one another. As illustrated, an opening is respectively formed through the topmost first and second layers 102, 104 of ceramic green tape. Once the layers 102, 104 of ceramic green tape are arranged over the ceramic green tapes 106 for lamination, a cavity 108 is thereby defined. Due to the above structure, the press-bonding tool 110 used in the lamination process usually has to be provided with a protruding portion 112 that matches with the shape and size of the cavity 108 in order to prevent damages of the cavity 108 in press-bonding. Since the depth of the cavity 108 is usually smaller than 250 microns, the machining cost of the protruding portion 112 required to match with the cavity 108 is usually high, and increases the production cost of the packaging substrate. The increase of the production cost may be further exacerbated and unrealizable as the size, location and shape of the cavity may be modified, and re-machining of a protruding portion 112 in the press-bonding tool is necessary. The above conventional method is therefore not adapted to a current demand for a more economical fabrication process of the packaging substrate.

### SUMMARY OF INVENTION

An aspect of the invention is therefore to provide a lamination process in the fabrication of a packaging substrate that allows the formation without damage of a cavity inside the packaging substrate.

Another aspect of the invention is to provide a lamination process in the fabrication of a packaging substrate that simplifies the shape of the pressing plates of the press-bonding tool used in the lamination process.

To accomplish the above and other objectives, a lamination process in the fabrication of a packaging substrate starts with the provision of a first substrate layer and a second substrate layer, respectively formed by stacking a plurality of green tapes. The first substrate layer has an opening therein and is arranged on a top surface of the second substrate layer in a manner that the opening exposes a portion of the top surface of the second substrate layer. A fill material is formed in the opening and is subsequently solidified. The first and second substrate layers then are heated and press-bonded by means of two planar pressing plates of a press-bonding tool. The fill material then is removed, and the first and second substrate layers are sintered to form the packaging substrate.

According to a preferred embodiment, the fill material is formed under liquid form in the cavity, and is made of a rubber-based material that effectively share the strain produced during the press-bonding. In an alternative embodiment, the rubber-based material can be rubber, epoxy resin, or mixtures of high molecular weight materials and adhesive. Furthermore, the green tapes are constituted of ceramic powder, glass, and a binder.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A through FIG. 1C are schematic views illustrating a ceramic green tape lamination process in the fabrication of a packaging substrate known in the art; and

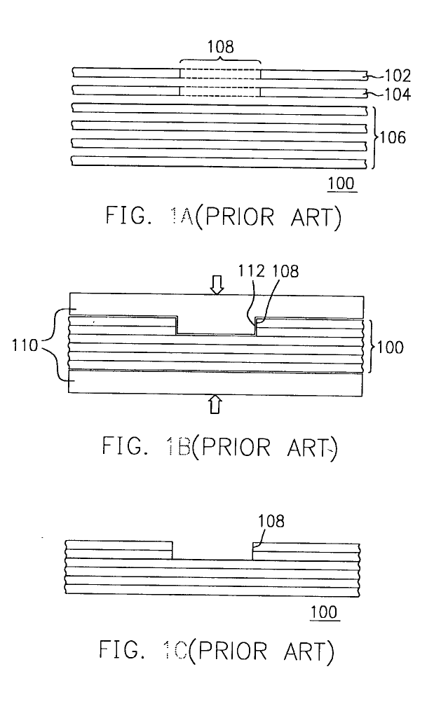

FIG. 2 through FIG. 4 are schematic views illustrating a ceramic green tape lamination process in the fabrication of a packaging substrate according to an embodiment of the invention.

### DETAILED DESCRIPTION

The following detailed description of the embodiments and examples of the present invention with reference to the accompanying drawings is only illustrative and not limiting. Furthermore, wherever possible in the description, the same reference symbols will refer to similar elements and parts unless otherwise illustrated in the drawings.

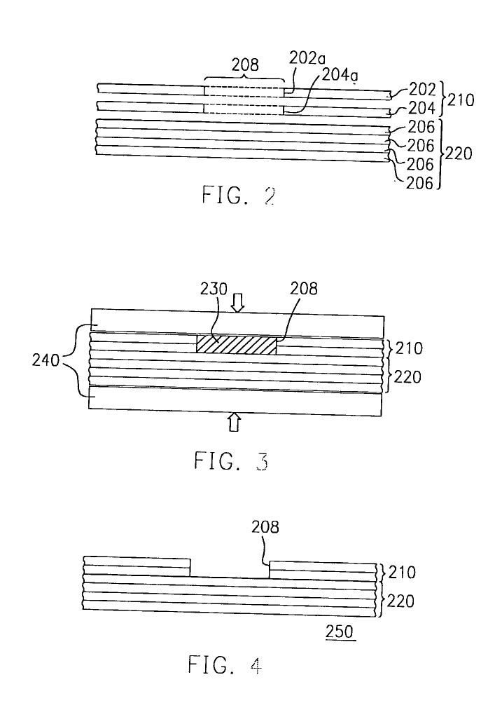

Reference now is made to FIG. 2 through FIG. 4 to describe a lamination process in the fabrication of a packaging substrate, in particular a low-temperature co-fired ceramic (LTCC) or high-temperature co-fired ceramic (HTCC) packaging substrate, according to an embodiment of the invention.

Referring to FIG. 2, the lamination process starts with the provision of a multi-layer structure formed by stacked layers of ceramic green tapes, for example, six tapes. The green tapes typically include an inner printed circuit comprised of wiring traces interconnected through via holes that are filled with a conductive material (not shown). Particularly, the topmost first and second layers 202, 204 of green tapes are respectively provided with openings 202a, 204a and define a first substrate layer 210. The openings 202a, 204a are formed by, for example, laser ablation or mechanical drilling. The third layer through the sixth layers of green tapes 206 form a second substrate layer 220. When the first substrate layer 210 is laminated over the top surface of the second substrate layer 220, the openings 202a, 204a form a cavity 208 that partially exposes the top surface of the second substrate layer 220 for subsequently receiving the mount of a chip or a passive component therein (not shown). The depth of the cavity 208 is usually smaller than 250 microns, but other dimensions may be adequate.

When the chip mounted in the cavity 208 operates, a substantial amount of heat may be irradiated. To improve the heat dissipation, a thermal plug or heat sink (not shown) further may be either formed at a bottom of the cavity 208 and/or in contact with the rear surface of the chip to promote heat dissipation. Another advantage of the cavity 208 is the shortening of the wire length that electrically connects the chip to the packaging substrate 200, which reduces the signal path and, consequently, the generation of parasitic inductance between the conductive wires.

Referring to FIG. 3, a fill material 230 is formed in the cavity 208, preferably under liquid form. If the depth of the cavity is smaller than 250 microns, printing or paste-dispensing methods may be implemented to fill the material 230. After solidification of the fill material 230, a press-bonding tool 240 is used to press and bond the first and second substrate layers 210, 220. Preferably, the fill material 230 is made of a rubber-based material, and in an alternative embodiment, the rubber-based material can be rubber, epoxy resin, or mixtures of high molecular weight materials and adhesive. The fill material 230, after solidification, has a Poisson's ratio approximately similar to that of the green tapes. Therefore, the strain inside the fill material 230 and the strain inside the green tapes, produced when the pressure from the tool 240 is exerted, are substantially identical. As a result, the fill material and the green tapes uniformly receive the pressure from the tool 240, and press-bonding is thereby performed without damageable deformation of the shape of the cavity 208. Since the fill material 230 is easily filled under liquid form in the cavity 208, the tool 240 therefore does not need the provision of a protruding portion on the pressing surface of its pressing plate matching with the size and shape of the cavity 208. According to the invention, the press-bonding tool 240 therefore has a simpler structure consisting of two pressing plates with planar pressing surfaces that, in operation, exert a pressure of about 3000 psi at a temperature of about 75° C.

Referring to FIG. 4, after press-bonding has been achieved, the fill material 230 is removed, and the first and second press-bonded substrate layers 210, 220 are sintered to form a packaging substrate 250. This sintering process typically includes a first thermal process in which organic agents within the green tapes are evaporated at a low temperature, and a second thermal process in which the ceramic/glass within the green tapes are sintered and solidified at a high temperature (typically 850° C).

As described above, the method of the invention therefore fabricates a packaging substrate that is provided with a cavity having a strictly-controlled shape for receiving an electronic device. This is achieved via forming a fill material under liquid form in the formed cavity. After solidification of the fill material, the substrate structure is press-bonded between two planar pressing plates of a press-bonding tool. Press-bonding is thereby performed without altering the shape of the cavity. After press-bonding has been achieved, the fill material is removed. The fabrication cost of the packaging substrate is therefore reduced without the need of specific machining of the pressing plates of the press-bonding tool.

It should be apparent to those skilled in the art that other structures that are obtained from various modifications and variations of different parts of the above-described structures of the invention would be possible without departing from the scope and spirit of the invention as illustrated herein. Therefore, the above description of embodiments and examples only illustrates specific ways of making and performing the invention that, consequently, should cover variations and modifications thereof, provided they fall within the inventive concepts as defined in the following claims.

1. A fabrication process of a packaging substrate, comprising:
forming a first substrate layer and a second substrate layer, wherein the first substrate layer includes an opening therein;
placing the first substrate layer on a top surface of the second substrate layer in a manner that the opening exposes the top surface of the second substrate layer;
forming a fill material in the opening and solidifying the fill material;
heating and press-bonding the first and second substrate layers, wherein the fill material receives a pressure from the press-bonding;
removing the fill material; and
sintering the first and second substrate layers.

2. The process of claim 1, wherein the first and second substrate layers are comprised of stacked ceramic green tapes that are respectively constituted of a ceramic powder, glass, and a binder.

3. The process of claim 1, wherein the fill material is a rubber-based material.

4. The process of claim 1, wherein the fill material is made of rubber, epoxy resin, or mixtures of high molecular weight materials and adhesive.

5. The process of claim 1, wherein the opening in the first substrate layer is formed by laser ablation.

6. The process of claim 1, wherein the fill material is formed under liquid form by printing or dispensing.

7. A lamination process for forming a laminated substrate from a plurality of stacked substrate layers, wherein at least a topmost substrate layer includes an opening therein, the lamination process comprising:
forming a fill material in the opening and solidifying the fill material; and
heating and press-bonding the substrate layers, wherein the fill material receives a pressure exerted by the press-bonding.

8. The process of claim 7, wherein the substrate layers are comprised of stacked ceramic green tapes that are respectively constituted of a ceramic powder, glass, and a binder.

9. The process of claim 7, wherein the fill material is a rubber-based material.

10. The process of claim 7, wherein the fill material is made of rubber, epoxy resin, or mixtures of high molecular weight materials and adhesive.

11. The process of claim 7, wherein the fill material is formed under liquid form by printing or dispensing.

12. The process of claim 7, wherein the substrate layers are press-bonded between two planar pressing plates.
